(19) United States
(12) Patent Application Publication
(10) Pub. No.: US 2018/0215299 A1
(43) Pub. Date: Aug. 2, 2018

(54) Non-slip Automobile Floor Mat

(71) Applicant: Yong B. Jung, Vernon, CA (US)

(72) Inventor: Yong B. Jung, Vernon, CA (US)

(73) Assignee: Jaenam Coe, Los Angeles, CA (US)

(21) Appl. No.: 15/421,288

(22) Filed: Jan. 31, 2017

(51) Int. Cl. B60N 3/04; B32B 3/30

(52) U.S. Cl. CPC B60N 3/046; B32B 3/30; B32B 2471/04; B32B 2307/744; B32B 2605/003; B60N 3/044

(57) ABSTRACT

A non-slip floor mat for carpeted surface, typically of automobiles, comprising of bottom surface covered with embedded tiny prongs in random directional orientations, in the shape of uneven v, which are designed to be caught in the pile loop of the carpeted surface of the automobile and remain stuck and resist lateral movement when pressure from the top is exerted or simply by gravity.

### BACKGROUND

Conventional floor mats as found in the automobiles employ various mechanical type of locks to prevent the mat's lateral movement or slipping on the surface of the floor where they are placed. The lateral movement or slipping of the mat resulting from the lateral pressures or movement of the feet of the occupants of the vehicle exerted on the mats impose threats to safety of the occupants. The conventional method which employ locking down and holding the mat through typically two points in the corners of the mat on the floor have limited effect in keeping the mat resistant to slipping and rolling in all directions. The prevention of the mats from slipping or lateral movement in a more convenient and effective way than conventional solution is the result that the present invention purports to achieve.

### SUMMARY

The present invention incorporates a new design of the slip-resistant floor mats when placed on top of carpeted surface, typically on the floor of the automobiles, incorporating specially designed friction-inducing surfaces.

An object of an embodiment of the present invention is to provide a slip-resistant floor mat to be placed on the carpeted surface of passenger automobiles or any other place where the non-slip quality of the floor mat is important for safety. The bottom surface of the slip-resistant floor mat achieve the increased friction or slip-resistance through multitude of small feet, placed in multitude of directions, which anchor themselves when pressured into the fiber loops of carpeted surface onto which the floor mat rests. The small feet embedded on the bottom surface of the mat are shaped like inverted “v” with the two prongs of uneven length facing downward toward the carpeted surface where the mat is placed. The small feet's prongs, thin enough to penetrate into the piles of carpets, and rigid enough to resist bending when pushed laterally, will cause anchoring of the mat on the carpeted surface it is placed.

It is to be understood that both the foregoing general description and the following detailed description are exemplary and explanatory only, and are not restrictive of the invention as claimed.

### DESCRIPTION OF THE DRAWINGS

These and other features, aspects, and advantages of the present invention will become apparent from the following description, appended claims, and the accompanying exemplary embodiments shown in the drawings, which are briefly described below.

Embodiments of the present invention will be described below with reference to the drawings. It should be noted that, in the following description, terms “upper”, “lower”, “above”, and “below” refer to “upper”, “lower”, “above”, and “below” in the drawings, respectively, and the terms “right”, “left”, “rightward, and “leftward” refer to “right”, “left”, “rightward, and “leftward” refer to “right”, “left”, “rightward, and “leftward” in the drawings, respectively.

FIG. 1 is a prospective view of the Non-Slip Mat on top of carpeted surface of a vehicle.

FIG. 2 is detail of cross-sectional view of the Non-Slip Mat according to an embodiment of the present invention.

FIG. 3 is a cross-sectional side view of the Non-Slip Mat according to an embodiment of the present invention above the carpeted surface of the vehicle's floor.

FIG. 4 shows the sectional side view of Non-Slip Mat and the floor surface under the mat on the vehicle's floor.

### DETAILED DESCRIPTION

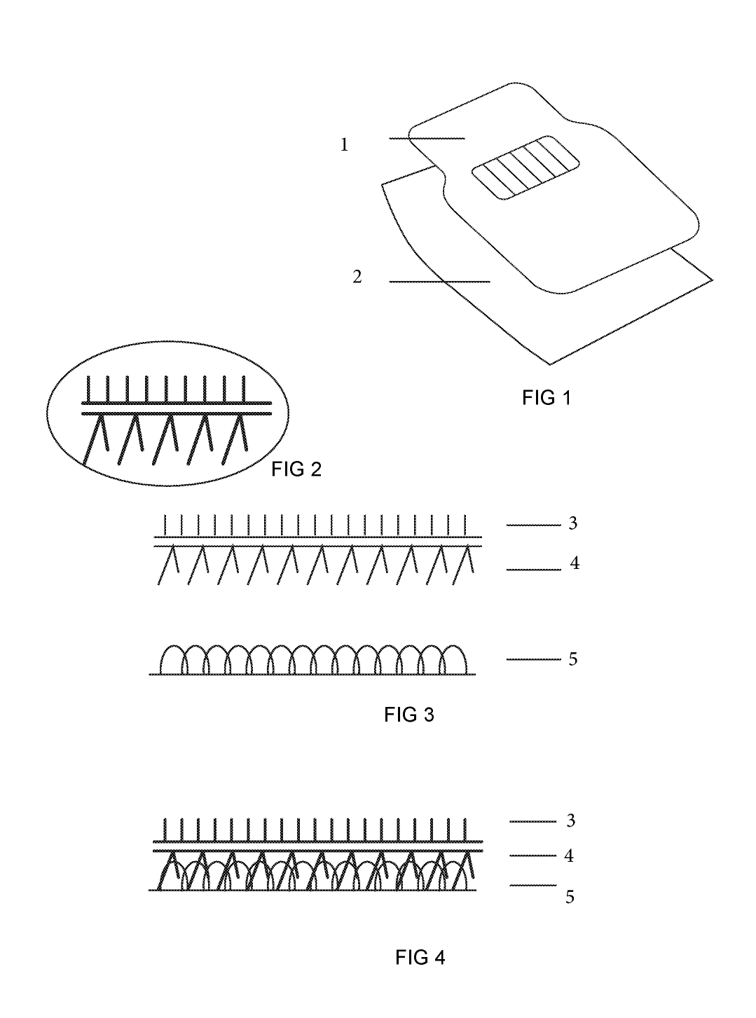

FIG. 1 show the Non-Slip Mat (1) above the carpeted floor surface of a vehicle.

FIG. 2 and FIG. 3 show the cross-sectional view of the Non-Slip Mat, where the numerous inverse v-shaped feet (4) attached to the bottom surface of the Mat form multitudes of tiny anchors protruding and being trapped on the pile (5) of the carpeted surface of the vehicle's floor. The inverted v-shaped feet are designed to penetrate into the pile when the pressure is exerted from the top of the mat onto the carpeted surface of the vehicle where the mat is placed, either through stepping on to them or simply by the gravity. The inverted v-shaped feet, (4) with the size and length, thin and small enough to penetrate into and be easily stuck onto the piles of the carpet, typically the thickness of thin needles and the length in the vicinity of ¼ inch to ⅓ inch, would be made of metal, carbon or plastics with sufficient rigidness to maintain the anchoring action once they embed the prongs into the piles. (5) The anchoring action of the v-shaped feet will make the mat lateral-movement proof once the pressure from the top is exerted.

FIG. 4 shows cross-sectional view of the Non-Slip mechanism in action where the inverse v-shaped feet lock onto the piles of the carpeted surface of the vehicle's floor.

What is claimed is:

1. A non-slip floor mat, for placing on top of carpeted surfaces, comprising of:
A top surface,
Middle layer and
A bottom surface with multitudes of inverted v-shaped feet, embedded and affixed to the mat, with prongs to penetrate into and anchor on the pile of the carpeted surface the mat is placed.

2. A non-slip floor mat as set forth in claim 1 with the inverted v-shaped feet, where each prong of the feet are of odd length, enhancing the chance for random catching and gripping of the pile of the carpeted surface onto which they are placed.

3. A non-slip floor mat as set forth in claim 1 where the inverted v-shaped feet are placed in all directional orientations to prevent slipping in all directions.

4. An non-slip floor mat as set forth in claim 1 where the inverted v-shaped feet cover the bottom surface of the mat.

5. A non-slip inducing, inverted v-shaped foot with two prongs, as set forth in claim 2, made of metal, carbon or plastic with sufficient rigidness to prevent bending and slipping over the piles of the carpeted surface onto which the prongs protrude.

6. A non-slip inducing, inverted v-shaped foot as set forth in claim 2 where the prongs of the inverted v-shaped foot are thin and small enough to penetrate into the piles of the carpeted surface onto which they are placed.
